(19) United States
(12) Patent Application Publication
(10) Pub. No.: US 2024/0170755 A1
(43) Pub. Date: May 23, 2024

(54) BATTERY PACK AND DEVICE INCLUDING THE SAME

(71) Applicant: LG ENERGY SOLUTION, LTD., Seoul (KR)

(72) Inventors: Juhwan SHIN, Daejeon (KR); Soon Chang HONG, Daejeon (KR); Hyongseok YOO, Daejeon (KR); Haejin KIM, Daejeon (KR)

(73) Assignee: LG ENERGY SOLUTION, LTD., Seoul (KR)

(21) Appl. No.: 18/282,895

(22) PCT Filed: Jul. 8, 2022
(86) PCT No.: PCT/KR2022/009995

§ 371 Date: Sep. 19, 2023

(30) Foreign Application Priority Data
Jul. 12, 2021 (KR) 10-2021-0091134

(51) Int. Cl. H01M 10/613; H01M 10/625; H01M 10/6568; H01M 50/249

(52) U.S. Cl. CPC H01M 10/613; H01M 10/625; H01M 10/6568; H01M 50/249; H01M 2220/10; H01M 2220/20

(57) ABSTRACT

A battery pack includes a battery module; a pack frame that houses the battery module and has a through-hole formed on one surface thereof; a cooling port that is inserted into the through hole; a cooling connector that is located inside the pack frame and is connected to the cooling port; a cover member that is coupled to the cooling port and has an opening part formed therein; and a pack coolant tube that is connected to the cooling connector. The cooling port includes a plate-shaped base part and a first tube that protrudes from the base part in a first direction and passes through the through hole. The base part includes a base protrusion part formed on one surface of the base part in the first direction. A sealing member is located between the opening of the cover member and the base protrusion part.

### TECHNICAL FIELD

### Cross Citation with Related Application(s)

This application claims the benefit of Korean Patent Application No. 10-2021-0091134 filed on Jul. 12, 2021, with the Korean Intellectual Property Office, the entire contents of which are incorporated herein by reference.

The present disclosure relates to a battery pack and a device including the same, and more particularly, to a battery pack having a liquid-cooled type cooling structure and a device including the same.

### BACKGROUND

In modern society, as portable devices such as a mobile phone, a notebook computer, a camcorder and a digital camera has been daily used, the development of technologies in the fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, the demand for development of the secondary battery is growing.

Currently commercialized secondary batteries include a nickel cadmium battery, a nickel hydrogen battery, a nickel zinc battery, and a lithium secondary battery. Among them, the lithium secondary battery has come into the spotlight because it has advantages, for example, hardly exhibiting memory effects compared to nickel-based secondary batteries and thus being freely charged and discharged, and having very low self-discharge rate and high energy density.

Such a lithium secondary battery mainly uses a lithium-based oxide and a carbonaceous material as a positive electrode active material and a negative electrode active material, respectively. The lithium secondary battery comprises an electrode assembly in which a positive electrode plate and a negative electrode plate, each being coated with the positive electrode active material and the negative electrode active material, are arranged with a separator being interposed between them, and a battery case which seals and houses the electrode assembly together with an electrolyte solution.

Generally, the lithium secondary battery may be classified into a can-type secondary battery in which the electrode assembly is mounted in a metal can, and a pouch-type secondary battery in which the electrode assembly is mounted in a pouch of an aluminum laminate sheet, depending on the shape of the exterior material.

In the case of a secondary battery used for small-sized devices, two to three battery cells are arranged, but in the case of a secondary battery used for a medium- and large-sized device such as automobiles, a battery module in which a large number of battery cells are electrically connected is used. In such a battery module, a large number of battery cells are connected to each other in series or parallel to form a cell assembly, thereby improving capacity and output. Further, one or more battery modules can be mounted together with various control and protection systems such as a BMS (battery management system) and a cooling system to form a battery pack.

When a secondary battery is heated over a proper temperature, the performance of the secondary battery may deteriorate, and in severe cases, the secondary battery may be exploded or catch fire. In particular, a plurality of secondary batteries, that is, a battery module or a battery pack having battery cells can accumulate the heat emitted from the plurality of battery cells in a narrow space, which may raise the temperature of the battery module quickly and severely. In other words, a battery module including a large number of battery cells, and a battery pack equipped with such a battery module can obtain high output, but it is not easy to remove heat generated from the battery cells during charging and discharging. When the heat dissipation of the battery cell is not properly performed, deterioration of the battery cells is accelerated, the lifespan is shortened, and the possibility of explosion or ignition increases.

Moreover, if a medium- and large-sized battery module is included in a battery pack for a vehicle, the battery module may be frequently exposed to direct sunlight and may be placed under high-temperature conditions, for example, in summer or in a desert.

Therefore, when configuring a battery module or battery pack, it may be very important to ensure stable and effective cooling performance. Particularly, in recent years, as the capacity of a battery module or battery pack increases, the amount of heat generation increases, wherein a liquid-cooled type cooling structure rather than an air-cooled type cooling structure is required to control the increased heat generation amount. In the case of a liquid-cooled type cooling structure, cooling performance is excellent, but a sealing structure that prevents coolant from flowing out into the battery pack is essentially required.

As the demand for increased battery pack capacity and improved heat dissipation performance are consecutive, it may be practically necessary to develop a battery pack comprising a cooling system with a stable sealing structure.

### DETAILED DESCRIPTION OF THE INVENTION

### Technical Problem

It is an object of the present disclosure to provide a battery pack which is improved in sealing property for preventing leakage of the coolant in a liquid-cooled type cooling structure, and assembling property in the process of realizing the cooling structure, and a device including the same.

However, the problem to be solved by embodiments of the present disclosure is not limited to the above-described problems, and can be variously expanded within the scope of the technical idea included in the present disclosure.

### Technical Solution

According to one embodiment of the present disclosure, there is provided a battery module; a pack frame configured to house the battery module, the pack frame having a through-hole in one side thereof; a cooling port inserted into the through hole, the cooling port having a plate-shaped base part and a first tube protruding from the base part in a first direction to pass through the through hole, the base part having a base protrusion part protruding from one surface of the base part in the first direction; a cooling connector located inside the pack frame, the cooling connector being connected to the cooling port; a cover member coupled to the cooling port, the cover member having an opening part formed therein; a sealing member located between the opening part of the cover member and the base protrusion part; and a pack coolant tube that is connected to the cooling connector.

The cooling connector can be coupled to the first tube in a state where the first tube passes through the through hole.

An outer peripheral protruding part protruding in an outer peripheral direction may be located on an outer peripheral surface of the first tube.

The cooling connector may be hook-coupled to the outer peripheral protruding part.

The sealing member may be located between an inner peripheral surface of the opening part and an outer peripheral surface of the base protrusion part.

An inner diameter of the opening part may be larger than a diameter of the base protrusion part, so that a space in which the sealing member is seated can be defined between the opening part and the base protrusion part.

The cover member may be coupled to the one surface of the base part such that the first tube and the base protrusion part pass through the opening part in the first direction.

The cover member may be located between an outer surface of the one side of the pack frame and the base part.

The cover member may be mounted to the base part by hook coupling.

The cooling port may include a second tube protruding from the base part in a second direction opposite to the first direction.

The first tube and the second tube are in communication with each other to allow coolant to flow between the first tube and the second tube.

The base part may include at least one base hole part protruding from the base part in the first direction, and the at least one base hole part may be configured to receive a fastener extending through the one side of the pack frame.

A height of the at least one base hole part protruding from the one surface of the base part in the first direction may be equal to a thickness of the cover member adjacent to the at least one base hole part.

### Advantageous Effects

According to embodiments of the present disclosure, a space where the sealing member is located can be formed naturally through the coupling between the cooling port and the cover member, thereby being able to improve the sealing property of the coolant circulation structure and achieving structural simplification.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is an exploded perspective view showing a battery pack according to one embodiment of the present disclosure;

FIG. 2 is a perspective view showing one of the battery modules included in the battery pack of FIG. 1;

FIG. 3 is an exploded perspective view showing a state in which the module frame is removed from the battery module of FIG. 2;

FIG. 4 is a perspective view showing one of the battery cells included in the battery module of FIG. 3;

FIGS. 5 and 6 are partial perspective views which show a coupling relationship between a cooling port, a cover member, and a cooling connector according to one embodiment of the present disclosure;

FIG. 7 is a perspective view showing a cooling port according to one embodiment of the present disclosure;

FIG. 8 is a perspective view showing a state in which a cooling port and a cover member are coupled together according to one embodiment of the present disclosure;

FIG. 9 show perspective views which respectively show a cooling port and a cover member according to one embodiment of the present disclosure;

FIG. 10 is a perspective view which shows a state in which a cooling port, a cover member, and a sealing member are coupled together according to one embodiment of the present disclosure;

FIG. 11 is a partial perspective view showing a state before the first tube of the cooling port and the cooling connector are coupled inside the pack frame;

FIG. 12 is a cross-sectional view showing a cross section taken along the cutting line A-A′ in FIG. 11;

FIG. 13 is a perspective view showing a cooling port according to a comparative example of the present disclosure; and

FIG. 14 is a partial perspective view showing a cooling port, a coupling bracket, and a sealing member according to another comparative example of the present disclosure.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the description, when a portion is referred to as “including” or “comprising” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

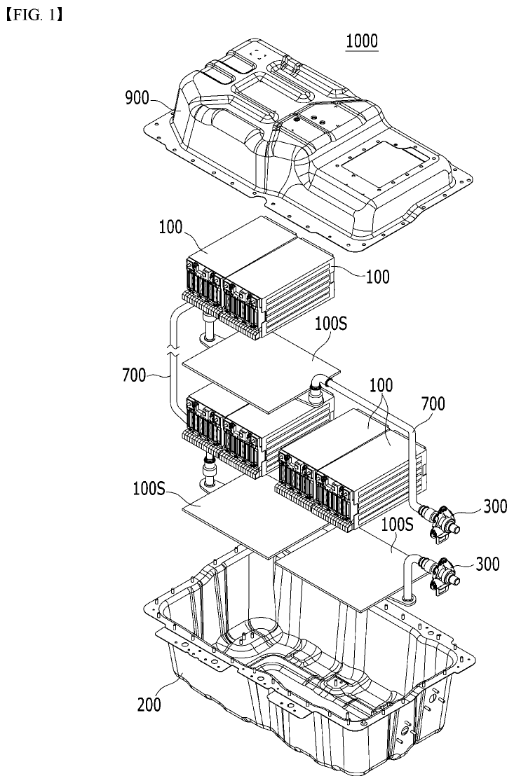

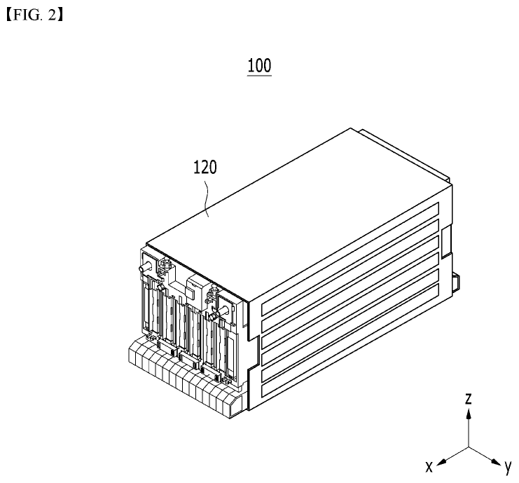

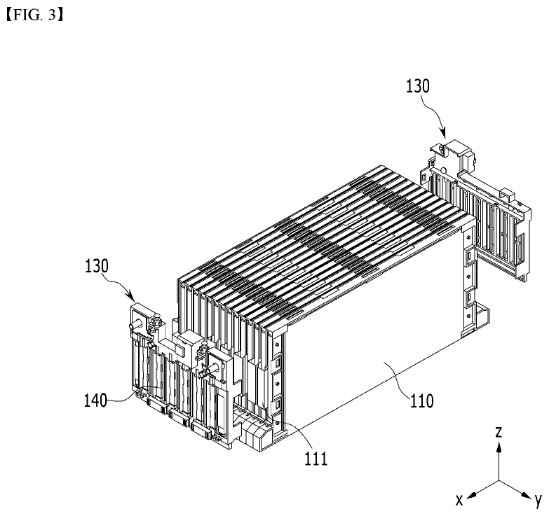

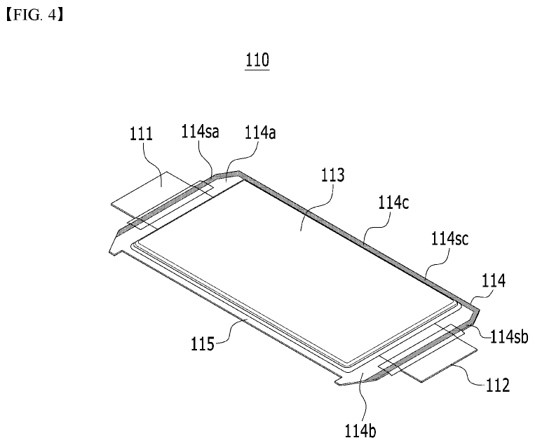

FIG. 1 is an exploded perspective view showing a battery pack according to one embodiment of the present disclosure. FIG. 2 is a perspective view showing one of the battery modules included in the battery pack of FIG. 1. FIG. 3 is an exploded perspective view showing a state in which the module frame is removed from the battery module of FIG. 2. FIG. 4 is a perspective view showing one of the battery cells included in the battery module of FIG. 3.

Referring to FIGS. 1 to 4, the battery pack 1000 according to one embodiment of the present disclosure includes a battery module 100 and a pack frame 200 that houses the battery module 100. The number of battery modules 100 housed in the pack frame 200 is not particularly limited, and one or a plurality of battery modules 100 can be housed.

First, the battery module 100 according to the present embodiment may include a plurality of battery cells 110 and a module frame 120 in which battery cells 110 are housed.

The battery cell 110 according to the present embodiment may be a pouch-type battery cell. Such a pouch-type battery cell may be formed by housing an electrode assembly in a pouch case of a laminated sheet including a resin layer and a metal layer, and then fusing the outer peripheral part of the pouch case. Such battery cells 110 may be formed in a rectangular sheet-like structure.

Specifically, referring to FIG. 4, the battery cell 110 according to the present embodiment may have a structure in which two electrode leads 111 and 112 face each other and protrude from one end 114a and the other end 114b of the cell main body 113, respectively. The battery cell 110 can be produced by joining both ends 114a and 114b of a battery case 114 and one side part 114c connecting them in a state in which an electrode assembly (not shown) is housed in a battery case 114. In other words, the battery cell 110 according to one embodiment of the present disclosure has a total of three sealing parts 114sa, 114sb and 114sc, wherein the sealing parts 114sa, 114sb and 114sc have a structure that is sealed by a method such as fusion, and the remaining other side part may be composed of a connection part 115. Between both ends 114a and 114b of the battery case 114 may be defined as the longitudinal direction of the battery cell 110, and between one side part 114c connecting both ends 114a and 114b of the battery case 114 and the connection part 115 may be defined as a width direction of the battery cell 110.

However, the above-mentioned battery cell 110 is an exemplary structure, and it goes without saying that a unidirectional battery cell in which two electrode leads protrude in the same direction is also possible.

The battery cell 110 may be composed by a plurality of numbers, and the plurality of battery cells 110 may be stacked so as to be electrically connected to each other. For example, as shown in FIG. 3, a plurality of battery cells 110 may be stacked along the direction parallel to the y-axis. The battery cell case 114 is generally formed in a laminated structure of resin layer/metal thin film layer/resin layer. For example, when the surface of the battery case is formed of an O (oriented)-nylon layer, it tends to slide easily due to external impact when stacking a plurality of battery cells to form a medium- and large-sized battery module. Therefore, in order to prevent this problem and maintain a stable stacked structure of battery cells, an adhesive member such as a cohesive-type adhesive such as a double-sided tape or a chemical adhesive bonded by chemical reaction during adhesion can be attached to the surface of the battery case to form a battery cell stack.

The module frame 120 is a structure for housing a plurality of battery cells 110, which may be a metal plate-shaped mono frame in which the upper surface, the lower surface, and both side surfaces are integrated. However, this is an exemplary structure, and both a form in which an upper cover is joined to a U-shaped frame with an open upper part and a form in which a U-shaped frame and an inverted U-shaped frame are coupled with each other, or the like, are all possible.

Meanwhile, referring to FIG. 3, the battery module 100 according to the present embodiment may further include a busbar frame 130 and a busbar 140 mounted on the busbar frame 130. Specifically, the busbar frame 130 can be located on the one side (x-axis direction) and the other side (−x-axis direction) of the battery cells 110, respectively. The one side (x-axis direction) and the other side (−x-axis direction) correspond to the direction in which the electrode leads 111 and 112 of the battery cells 110 protrude. A lead slit may be formed at the busbar frame 130, and the electrode leads 111 and 112 of the battery cells 110 can be bent after passing through the lead slit, and joined to the busbar 140. As long as physical and electrical connection is possible, the joining method is not particularly limited, and weld-joining can be performed as an example. That is, the battery cells 110 may be electrically connected to each other via the busbar 140.

Meanwhile, referring to FIGS. 1 and 2 again, the battery pack 1000 according to the present embodiment may further include a heat sink 100S that is located on one side of the battery module 100. As an example, a heat sink 100S may be located under each battery module 100. The heat sink 100S is a component through which coolant flows, and has a function of cooling the battery module 100 that generates heat. In addition, the battery pack 1000 according to the present embodiment includes a pack coolant tube 700 housed in the pack frame 200. The pack coolant tube 700 may be connected to the heat sink 100S, and may supply the coolant to the inside of the heat sink 100S or discharge the coolant from the heat sink 100S. That is, the pack coolant tube 700 may be provided for the coolant circulation structure of the heat sink 100S.

Meanwhile, a pack cover 900 may be located in the upper part of the pack frame 200. Other electrical components including the battery module 100, the heat sink 100S, and the pack coolant tube 700 may be housed between the pack frame 200 and the pack cover 900.

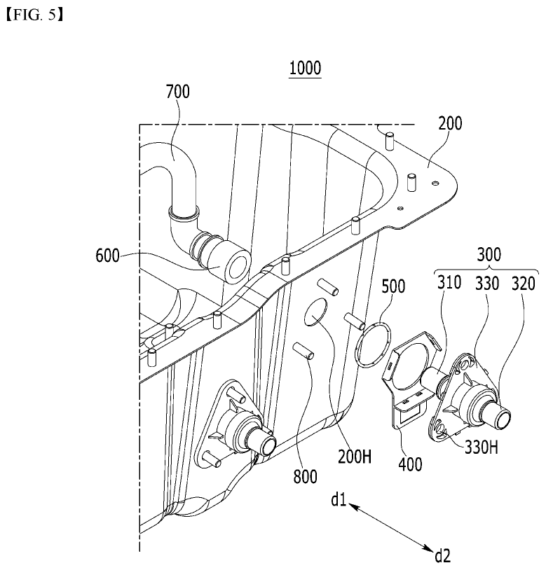

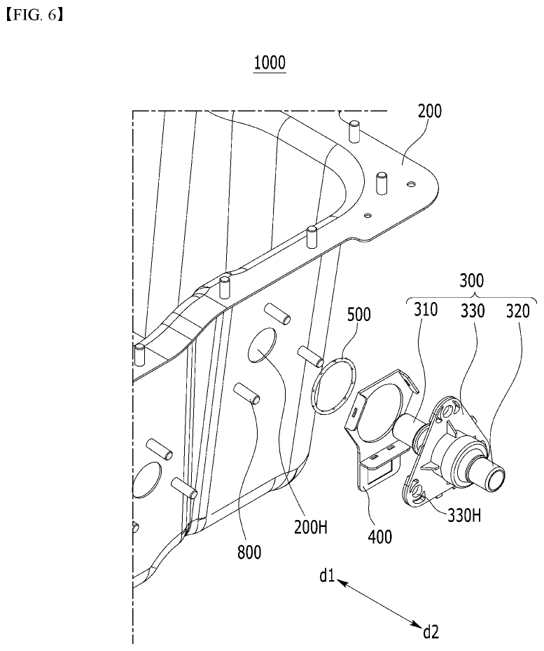

Next, the cooling port, the cover member and the cooling connector according to the present embodiment will be described with reference to FIGS. 5 and 6.

FIGS. 5 and 6 are partial perspective views which show a coupling relationship between a cooling port, a cover member, and a cooling connector according to one embodiment of the present disclosure. In FIG. 6, the illustration of the pack coolant tube 700 and the cooling connector 600 of FIG. 5 is omitted.

Referring to FIGS. 1, 5 and 6, a through hole 200H is formed on one surface of the pack frame 200. The battery pack 1000 according to the present embodiment includes a cooling port 300 that is inserted into the through hole 200H; a cooling connector 600 that is located inside the pack frame 200 and is connected to the cooling port 300; and a cover member 400 that is coupled to the cooling port 300 and has an opening part formed therein. At this time, the pack coolant tube 700 is connected to the cooling connector 600. That is, the pack coolant tube 700 may connect the heat sink 100S and the cooling connector 600.

In the inside of the pack frame 200, a heat sink 100S of the battery module 100, a pack coolant tube 700, and a cooling connector 600 may be sequentially connected. Meanwhile, although not specifically shown in the figure, the cooling port 300 may be connected to a coolant supply/discharge system on the outside of the pack frame 200. As mentioned below, however, the cooling port 300 and the cooling connector 600 may be connected to each other via a through hole 200H formed in the pack frame 200. That is, the cooling port 300, the cooling connector 600, the pack coolant tube 700, and the heat sink 100S are sequentially connected, so that a coolant circulation structure for cooling the battery module 100 can be formed inside the battery pack 1000.

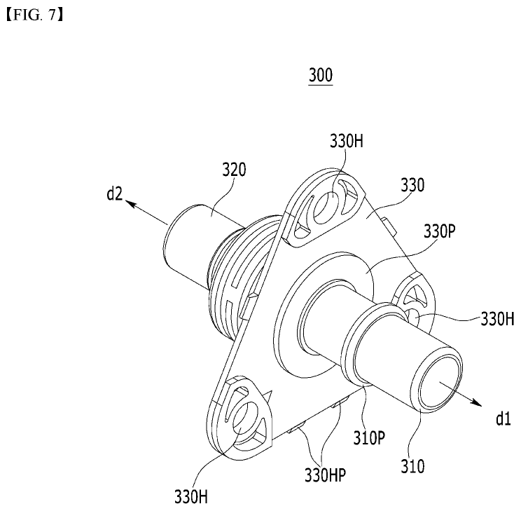

Next, the structures of the cooling port, the cover member and the cooling connector according to the present embodiment will be described in detail with reference to FIGS. 7 to 10 and the like.

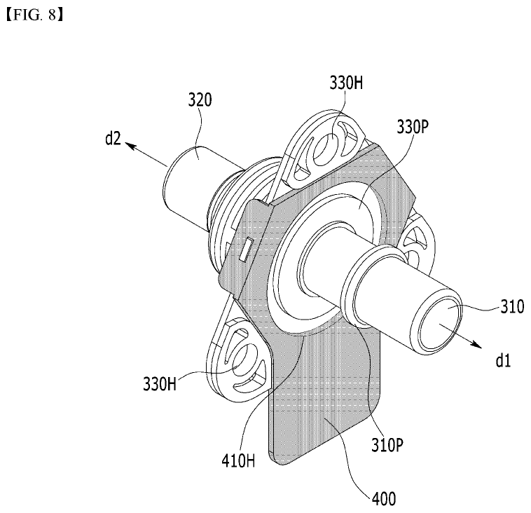

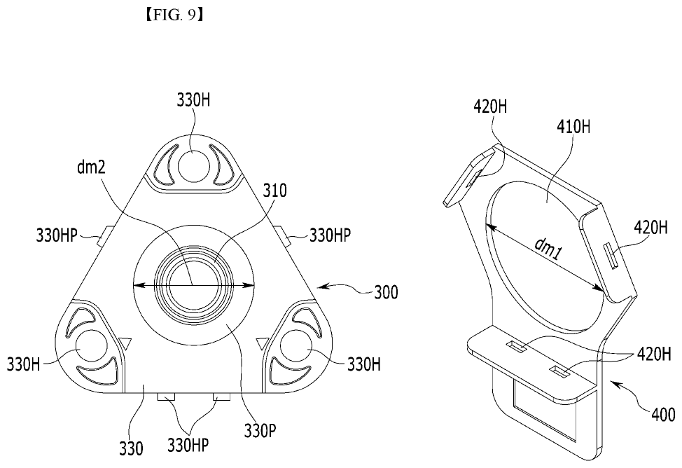

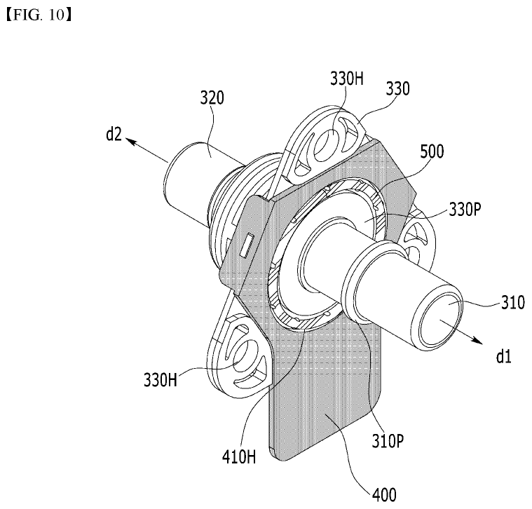

FIG. 7 is a perspective view showing a cooling port according to one embodiment of the present disclosure. FIG. 8 is a perspective view showing a state in which a cooling port and a cover member are coupled together according to one embodiment of the present disclosure. FIG. 9 shows perspective views which respectively show a cooling port and a cover member according to one embodiment of the present disclosure. FIG. 10 is a perspective view which shows a state in which a cooling port, a cover member, and a sealing member are coupled together according to one embodiment of the present disclosure. In FIGS. 8 and 10, the cover member 400 is shaded for convenience of explanation.

First, referring to FIGS. 5 to 9 together, the cooling port 300 according to one embodiment of the present disclosure includes a plate-shaped base part 330, and a first tube 310 that protrudes from the base part 330 in the first direction d1 and passes through the through hole 200H of the pack frame 200. Here, the first direction d1 may be a direction toward the inside of the pack frame 200 from the through hole 200H. In addition, the cooling port 300 may further include a second tube 320 that protrudes from the base part 330 in a second direction d2 opposite to the first direction d1. Here, the second direction may be a direction toward the outside of the pack frame 200 from the through hole 200H. The inside of the first tube 310 and the inside of the second tube 320 are connected to each other, and the coolant may flow in the inside of the first tube 310 and the inside of the second tube 320. The base part 330 includes a base protrusion part 330P formed on one surface of the base part 330 in the first direction d1. The base part 330 is illustrated as a plate-shaped member with rounded corners, but the shape thereof is not particularly limited as long as it is a plate-shaped member.

Referring to FIGS. 7 to 10, the cover member 400 having an opening part 410H formed therein is coupled to the cooling port 300 as described above. At this time, the sealing member 500 is located between the opening part 410H of the cover member 400 and the base protrusion part 330P. The sealing member 500 is an O-ring shaped member, and prevents coolant from leaking between the cooling port 300 and the through hole 200H.

Specifically, the cover member 400 may be coupled to one surface of the base part 330 in the first direction d1 such that the first tube 310 and the base protrusion part 330P pass through the opening part 410H. Thereby, as shown in FIG. 6, the cover member 400 may be located between the outer surface of the pack frame 200 and the base part 330 of the cooling port 300.

At this time, the opening part 410H may have a circular hole shape, and the base protrusion part 330P may also be a cylindrical protrusion part so as to correspond thereto. The inner diameter dm1 of the opening part 410H is configured to be larger than the diameter dm2 of the base protrusion part 330P, so that a space in which the sealing member 500 is seated can be formed between the opening part 410H and the base protrusion part 330P. That is, the sealing member 500 according to the present embodiment may be located between the inner peripheral surface of the opening part 410H and the outer peripheral surface of the base protrusion part 330P. More specifically, the sealing member 500 is fixed between the inner peripheral surface of the opening part 410H and the outer peripheral surface of the base protrusion part 330P, thereby being able to interrupt outflow of coolant between the cooling port 300 and the outer surface of the pack frame 200.

Meanwhile, the coolant use herein is a medium for cooling, and is not particularly limited, but cooling water may be used as an example. That is, the battery pack 1000 according to the present embodiment may have a water-cooled type cooling structure.

Meanwhile, the cover member 400 and the base part 330 according to the present embodiment may be fastened by a physical method. For example, the cover member 400 according to the present embodiment may be mounted to the base portion 330 by hook coupling. Specifically, hook protrusion parts 330HP may be formed on each side of the base part 330, and a hook groove 420H may be formed in the cover member 400 so as to correspond to the hook protrusion part 330HP. The cover member 400 and the base part 330 may be hook-coupled in such a way that the hook protrusion part 330HP is inserted into the hook groove 420H. However, this corresponds to one example, and as another embodiment, a hook protrusion part may be formed in the cover member and a hook groove may be formed in the base part. The number of hook projection parts and hook grooves are not particularly limited.

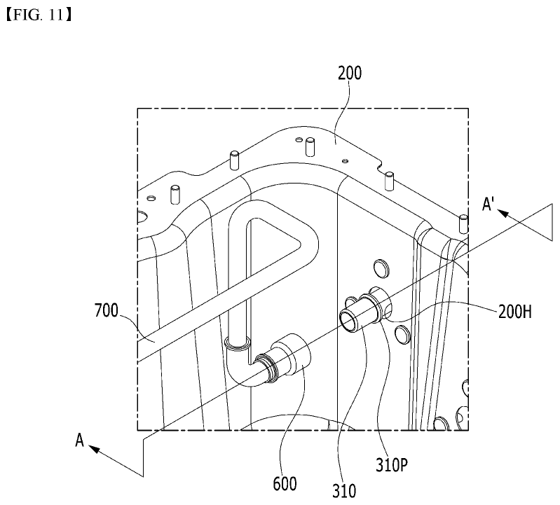

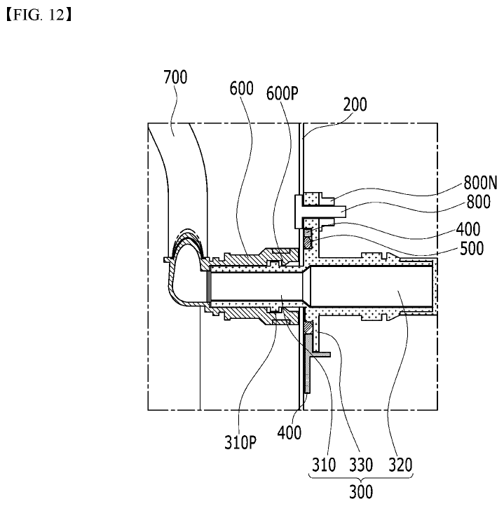

Next, the connection relationship between the first tube of the cooling port and the cooling connector according to the present embodiment will be described in detail with reference to FIGS. 11 and 12.

FIG. 11 is a partial perspective view showing a state before the first tube of the cooling port and the cooling connector are coupled inside the pack frame. FIG. 12 is a cross-sectional view showing a cross section taken along the cutting line A-A′ in FIG. 11. In particular, FIG. 12 is a cross-sectional view which assumes and shows a state where the cooling connector 600 and the first tube 310 of the cooling port 300 in FIG. 11 are coupled to each other.

Referring to FIGS. 10 to 12, in a state where the first tube 310 of the cooling port 300 according to the present embodiment passes through the through hole 200H of the pack frame 200, the cooling connector 600 can be coupled to the first tube 310. Also, as described above, the cooling connector 600 may be connected to the pack coolant tube 700. Meanwhile, on the outside of the pack frame 200, a state in which the sealing member 500 is located between the inner peripheral surface of the opening part 410H and the outer peripheral surface of the base protrusion part 330P is illustrated.

An outer peripheral protruding part 310P protruding toward an outer peripheral direction may be formed on the outer peripheral surface of the first tube 310, and an inner peripheral protruding part 600P may be formed on an inner peripheral surface of the cooling connector 600. As shown in FIG. 12, when the first tube 310 is inserted into the cooling connector 600, the inner peripheral protrusion part 600P of the cooling connector 600 may be hook-coupled to the outer peripheral protrusion part 310P of the first tube 310. In this manner, the first tube 310 and the cooling connector 600 may be coupled to each other in the inside of the pack frame 200.

Meanwhile, referring to FIGS. 6, 7, 9 and 12 together, a base hole 330H may be formed in the base part 330 according to the present embodiment, and a bolt part 800 may be located on the outer surface of the pack frame 200. The bolt part 800 passes through the base hole 330H, and then can be coupled to a nut part 800N. That is, the base part 330 may be fixed to the pack frame 200 in a bolt/nut coupling manner. The triangular base part 330 is illustrated, but the shape thereof is not particularly limited as long as it has a plate-like shape so that it can be fixed to the pack frame 200. The number of base holes 330H is also not particularly limited.

As described above, the second tube 320 according to the present embodiment protrudes in the second direction d2 toward the outside of the pack frame 200 from the through hole 200H, and may be connected to a coolant supply/discharge system outside the battery pack 1000. As an example, it may be connected to an external cooling tube or a cooling motor.

Advantages of the cooling port, the cover member, and the sealing member according to the present embodiment will be described below in comparison with comparative examples.

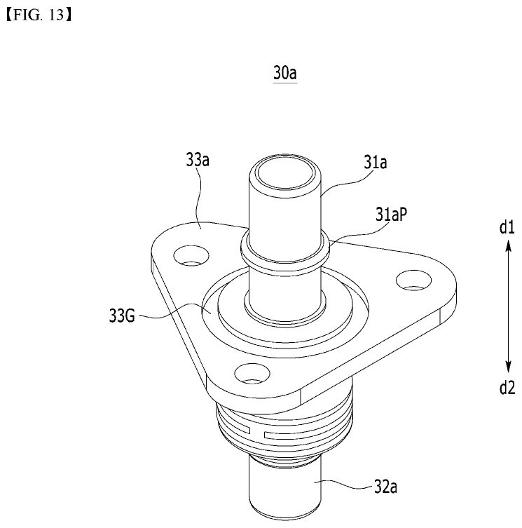

FIG. 13 is a perspective view showing a cooling port according to a comparative example of the present disclosure.

Referring to FIG. 13, a cooling port 30a according to a comparative example of the present disclosure may include a first tube 31a, a second tube 32a, and a base part 33a. The first tube 31a protrudes in a first direction d1, and the second tube 32a protrudes in a second direction d2 opposite to the first direction d1. The inside of the first tube 31a and the inside of the second tube 32a are connected to each other, so that a coolant can flow in the inside of the first tube 31a and the inside of the second tube 32a.

The first pipe 31a may be formed with an outer peripheral protruding part 31aP protruding toward an outer peripheral direction to be coupled with the cooling connector. At this time, the base part 33a may be formed with a recessed part 33G that is recessed so that an O-ring-shaped sealing member (not shown) is mounted.

In the manufacture of the cooling port 30a, an injection molding method can be used. In the injection molding method, however, in order to form the first tube 31a and the recessed part 33G, the mold must be pulled out in the first direction d1 or the second direction d2. In this case, the outer peripheral protruding part 31aP having a shape of protruding in directions perpendicular to the first and second directions d1 and d2 is hooked. As a result, when the cooling port 30a shown in FIG. 13 is manufactured by injection molding, there is a problem that an undercut occurs in the outer peripheral protruding part 31aP. That is, the outer peripheral protruding part 31aP and the recessed part 33G having a shape of being recessed cannot be simultaneously manufactured by injection molding.

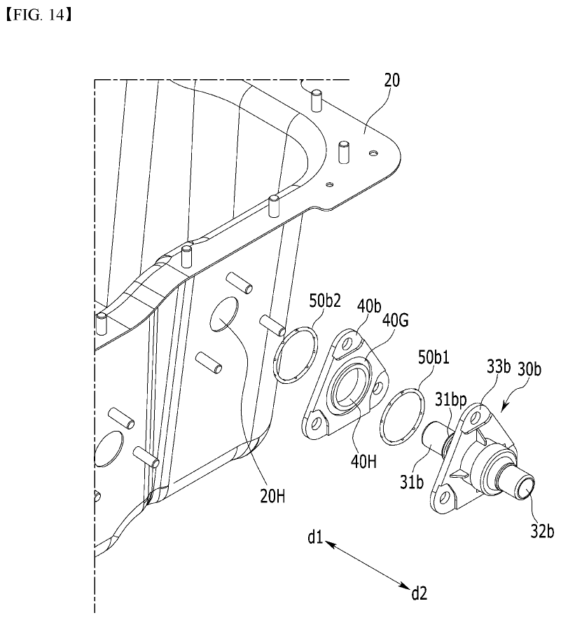

FIG. 14 is a partial perspective view showing a cooling port, a coupling bracket, and a sealing member according to another comparative example of the present disclosure.

Referring to FIG. 14, a cooling port 30b according to another comparative example of the present disclosure may include a first tube 31b, a second tube 32b, and a base part 33b. The first tube 31b protrudes in the first direction d1, and the second tube 32b protrudes in a second direction d2 opposite to the first direction d1. The inside of the first tube 31b and the inside of the second tube 32b are connected to each other, so that a coolant can flow in the inside of the first tube 31b and the inside of the second tube 32b. The first tube 31b may pass through the through hole 20H of the pack frame 20. An outer peripheral protruding part 31bp protruding toward an outer peripheral direction may be formed in the first tube 31b to be coupled with the cooling connector.

In order to solve the above problem associated with the cooling port 30a shown in FIG. 13, a separate coupling bracket 40b is added instead of forming a recessed part in the base part 33b of the cooling port 30b.

The coupling bracket 40b is located between the outer surface of the pack frame 20 and the base part 33b. An opening hole 40H is formed in the coupling bracket 40b, and the first tube 31b may pass through the opening hole 40H.

O-ring shaped sealing members 50b1 and 50b2 may be located both between the coupling bracket 40b and the base part 33b and between the coupling bracket 40b and the outer surface of the pack frame 20, respectively. Bracket recessed grooves 40G may be formed on each of both surfaces of the coupling bracket 40b so that the sealing members 50b1 and 50b2 can be seated.

That is, in this comparative example, a separate coupling bracket 40b having a bracket-recessed groove 40G is added without forming a recessed groove in the base part 33b itself in order to prevent the occurrence of undercut. However, since it is a form in which the coupling bracket 40b is interposed, the areas where a seal member must be added to prevent outflow of a coolant are increased to two places, between the coupling bracket 40b and the base part 33b and between the coupling bracket 40b and the outer surface of the pack frame 20. Undercut does not occur, but there is a drawback that the two sealing members 50b1 and 50b2 are required and the number of unnecessary parts increases. In addition, in the process of coupling between parts, the assembly position between the two sealing members 50b1 and 50b2, the coupling bracket 40b, and the base part 33b must be finely set, which complicates the manufacturing process. In other words, increasing the area where the sealing members 50b1 and 50b2 are required means increasing the area where the coolant can flow out. That is, it can be seen that the sealing property for preventing leakage of the coolant is deteriorated.

Meanwhile, the cooling port 300 according to the present embodiment can naturally provide a space where the sealing member 500 is located through coupling with the cover member 400. Therefore, defects such as undercuts do not occur in the manufacturing process, and there is no need to additionally interpose a sealing member. This leads to the advantage of reducing the required configuration and materials and potentially reducing costs. In addition, since it can be simply manufactured by mechanical coupling between the base part 330 and the cover member 400, the structure is simplified and the manufacturing process is simple. In addition, since the area where the sealing member is required is reduced as compared to the cooling port 30b of FIG. 14, it has the advantage that the risk of coolant outflow is small.

The terms representing directions such as the front side, the rear side, the left side, the right side, the upper side, and the lower side have been used in the present embodiment, but the terms used are provided simply for convenience of description and may become different according to the position of an object, the position of an observer, or the like.

One or more battery modules according to the present embodiment described above can be mounted together with various control and protection systems such as BMS (battery management system), an BDU (battery disconnect unit) and a cooling system to form a battery pack.

The battery pack can be applied to various devices. Specifically, it can be applied to vehicle means such as an electric bike, an electric vehicle, and a hybrid electric vehicle, or ESS (Energy Storage System), but is not limited thereto and can be applied to various devices capable of using a secondary battery.

Although preferred embodiments of the present disclosure have been shown and described above, the scope of the present disclosure is not limited thereto, and numerous changes and modifications can be devised by those skilled in the art using the principles of the invention defined in the appended claims, which also falls within the spirit and scope of the present disclosure.

1. A battery pack comprising:
a battery module;
a pack frame configured to house the battery module, the battery module having a through-hole in one side thereof;
a cooling port inserted into the through hole, the cooling port having a plate-shaped base part and a first tube protruding from the base part in a first direction to pass through the through hole, the base part having a base protrusion part protruding from one surface of the base part in the first direction;
a cooling connector located inside the pack frame, the cooling connector being connected to the cooling port;
a cover member coupled to the cooling port, the cover member having an opening part;
a sealing member located between the opening of the cover member and the base protrusion part; and
a pack coolant tube connected to the cooling connector.

2. The battery pack according to claim 1, wherein:
the cooling connector is coupled to the first tube in a state where the first tube passes through the through hole.

3. The battery pack according to claim 2, wherein:
an outer peripheral protruding part protruding in an outer peripheral direction is located on an outer peripheral surface of the first tube.

4. The battery pack according to claim 3, wherein:
the cooling connector is hook-coupled to the outer peripheral protruding part.

5. The battery pack according to claim 1, wherein:
the sealing member is located between an inner peripheral surface of the opening part and an outer peripheral surface of the base protrusion part.

6. The battery pack according to claim 1, wherein:
an inner diameter of the opening part is larger than a diameter of the base protrusion part, so that a space in which the sealing member is seated is defined between the opening part and the base protrusion part.

7. The battery pack according to claim 1, wherein:
the cover member is coupled to the one surface of the base part such that the first tube and the base protrusion part pass through the opening part in the first direction.

8. The battery pack according to claim 1, wherein:
the cover member is located between an outer surface of the pack frame and the base part.

9. The battery pack according to claim 1, wherein:
the cover member is mounted to the base part by hook coupling.

10. The battery pack according to claim 1, wherein:
the cooling port includes a second tube protruding from the base part in a second direction opposite to the first direction.

11. The battery pack according to claim 10, wherein:
the first tube and the second tube are in communication with each to allow a coolant to flow between the first tube and the second tube.

12. A device comprising the battery pack as set forth in claim 1.

13. The battery pack according to claim 1, wherein the base part includes at least one base hole part protruding from the base part in the first direction, the at least one base hole part configured to receive a fastener extending through the one side of the pack frame.

14. The battery pack according to claim 13, wherein a height of the at least one base hole part protruding from the one surface of the base part in the first direction is equal to a thickness of the cover member adjacent to the at least one base hole part.
